(19) United States
(12) Patent Application Publication
(10) Pub. No.: US 2018/0280839 A1
(43) Pub. Date: Oct. 4, 2018

(54) Filter Device for Separating Debris From a Fluid

(71) Applicant: ICON Construction and Property Maintenance LLC, West Milford, NJ (US)

(72) Inventors: Wayne Larry Davis, Sloatsburg, NY (US); Jeffrey John Melillo, West Milford, NJ (US)

(73) Assignee: ICON Construction and Property Maintenance LLC

(21) Appl. No.: 15/944,515

(22) Filed: Apr. 3, 2018

Related U.S. Application Data
(60) Provisional application No. 62/481,001, filed on Apr. 3, 2017.

(51) Int. Cl. B01D 29/00; B01D 29/05; B01D 35/30; B01D 35/02

(52) U.S. Cl. CPC B01D 29/0095; B01D 29/05; E03B 7/07; B01D 35/02; B01D 35/30

(57) ABSTRACT

The present invention relates to a filter device for separating debris from a fluid. The filter device includes a housing having at least one inlet, at least one first outlet, and a second outlet. The filter device further includes a filter cartridge that allows fluid to pass therethrough but prevents passage of debris therethrough. The filter cartridge is positioned within the housing so as to define an upper chamber and a lower chamber within the housing. The at least one inlet is positioned so as to allow contaminated fluid to enter the lower chamber of the housing. Fluid must pass through the filter cartridge in an upward direction to reach the upper chamber, and the first outlet is positioned so as to allow filtered fluid to exit the upper chamber. The second outlet is positioned to allow debris accumulated within the lower chamber to be discharged.

### CROSS-REFERENCE TO RELATED APPLICATION

This application claims the benefit under 35 U.S.C. § 119(e) to U.S. Provisional Patent Application No. 62/481,001, filed Apr. 3, 2017, the entire disclosure of which is incorporated herein by reference.

### BACKGROUND OF THE INVENTION

### Field of the Invention

The present invention relates to a device configured to separate debris, such as particulate matter, hair, solid matter, and other contaminants from a fluid so as to prevent or reduce the frequency of the clogging of a pipe, septic leach field, waterway, or the like through which the fluid flows.

### Description of Related Art

Hair salons, barbershops, pet groomers and the like generally have several sinks, tubs, or wash basins in which the workers wash or rinse a human's or animal's hair. As a result, the used water that flows through the drain and into the pipes may include a mixture of various substances such as water, shampoo, soap and hair products along with debris, such as dirt, particulate matter, loose hair, or hair clippings. Since several wash basins may be used frequently throughout the day, the hair that flows into the drains regularly builds up and clogs the pipes or other similar conduits or devices.

Conventionally, the workers must take the time to manually remove sections of pipe, clean the pipe to remove the clog, and reinstall the pipes in order to remove and/or prevent blockages. This can be time consuming, messy, and inconvenient.

While various filter devices exist in the prior art for filtering debris from a used or spent water stream, such as hair interceptors manufactured by ZURN®, among others, these filters are prone to frequent clogging, requiring continuous cleaning and/or replacement of the hair interceptor's filter. This is because many filters are positioned directly in the flow path of the wastewater stream, i.e., the filter is placed perpendicularly to the direction in which the wastewater is flowing. As a result, the flowing water forces debris into the filter, lodging the debris against the filter, which promotes clogging of the filter and reduces or inhibits the flow of water through the filter.

Therefore, an improved filter device is desired to prevent or minimize the blockage of pipes and other conduits by debris, and that enables a user to easily remove debris without having to remove and clean sections of piping. Further, a filter device having a filter element that is not positioned directly in the flow path of the fluid is desired so that debris is not driven into the filter element by gravity or by the incoming flow of the fluid, helping to prevent the filter from clogging and promoting fluid flow through the filter device.

### BRIEF SUMMARY OF THE INVENTION

The present invention relates to a filter device for removing debris from a fluid to prevent or minimize the clogging of a pipe, waterway, or other similar conduit through which the fluid flows to a waste system, such as a sewer or septic system. The filter device for separating debris from a fluid comprises a housing defining an interior volume, wherein the housing has at least one inlet, at least one first outlet, a second outlet, and a filter cartridge configured to prevent debris from passing therethrough while allowing fluid to flow therethrough, wherein the filter cartridge is positioned within the housing so as to define an upper chamber and a lower chamber within the housing, the at least one inlet is positioned such that a fluid can pass through the at least one inlet into the lower chamber of the housing, the at least one first outlet is positioned to allow fluid that has passed through the filter cartridge into the upper chamber to exit the housing through the at least one first outlet, and the second outlet is positioned so as to allow debris to be discharged from the lower chamber.

The housing may be configured as a rectangular prism. Alternatively, the housing may be substantially cylindrical. Further, the housing may have one or more sidewalls, wherein the filter cartridge extends between the one or more sidewalls such that a fluid entering the housing through the at least one inlet must pass through the filter cartridge in order to flow from the lower chamber to the upper chamber of the housing. The filter cartridge may be positioned substantially horizontally within the housing.

The at least one inlet may be positioned so as to direct fluid into the lower chamber of the housing in a substantially horizontal direction. The at least one inlet may be configured as an inlet tube having a first end and a second end, wherein the first end is disposed at an upper end of the housing, and the second end is disposed at a lower end of the housing and communicates fluid into the lower chamber of the housing. When the at least one inlet is configured as an inlet tube, at least a portion of the inlet tube may be positioned within the interior volume of the housing.

In another embodiment, the at least one inlet may be configured as an opening defined by a sidewall of the housing, such that fluid can flow from an exterior of the housing through the inlet into the interior volume of the housing.

The housing may include a flange defining an open portion, wherein the open portion provides access to the interior volume of the housing, and the filter device further comprises a door configured to removably cover the open portion of the housing. The door may comprise a plurality of openings that can be aligned with a plurality of openings on the flange when the door is in a closed configuration, such that a plurality of fasteners can be inserted through the aligned openings to secure the door to the flange.

The filter cartridge may comprise one or more filter plates, wherein each of the one or more filter plates comprises a perforated section having a plurality of apertures sized to prevent debris from passing therethrough. The perforated section of the one or more filter plates may be centrally located on the filter plate. The filter cartridge may be removably positioned within the housing.

The filter device may further comprise a filter support configured to maintain and secure the filter cartridge within the housing. The filter support may comprise one or more slots configured to receive the filter cartridge or a filter plate of the filter cartridge.

The second outlet may comprise a selectively openable closure that allows debris to be selectively removed from the lower chamber of the housing. The selectively openable closure of the second outlet may be a valve.

The filter device may further comprise a mounting plate fixed to the housing, wherein the mounting plate includes a plurality of apertures configured to receive fasteners therethrough and is configured to be positioned against a support surface for mounting the housing to the support surface. The housing may comprise stainless steel.

The present invention further relates to methods for filtering a fluid containing debris using a filter device of the type describe herein, comprising supplying a contaminated fluid containing debris into the housing via the at least one inlet, wherein the fluid passes upwardly through the filter cartridge from the lower chamber to the upper chamber and outwardly through the at least one first outlet, and wherein the debris is unable to pass through the filter cartridge and is retained in the lower chamber of the housing. The method may further include the step of opening a selectively openable closure of the second outlet so as to allow debris to be selectively removed from the lower chamber.

The present invention also relates to methods for filtering a fluid containing debris comprising supplying fluid to a filter device comprising a housing wherein a filter cartridge is positioned within the housing and is outside of the flow path of the fluid entering the housing, such that the fluid flows in a vertically upward direction through the filter cartridge.

### BRIEF DESCRIPTION OF THE SEVERAL VIEWS OF THE DRAWINGS

The foregoing summary, as well as the following detailed description of preferred embodiments of the invention, will be better understood when read in conjunction with the appended drawings. For the purpose of illustrating the invention, there is shown in the drawings embodiments which are presently preferred. It should be understood, however, that the invention is not limited to the precise arrangements and instrumentalities shown.

FIG. 1 is a perspective view of an embodiment of the filter device constructed in accordance with the present invention.

FIG. 2 is a top perspective view of the filter device of FIG. 1.

FIG. 3 is a front perspective view of the filter device of FIG. 1 with the door removed.

FIG. 4 is a perspective view of the interior of the filter device of FIG. 1.

FIG. 5 is a perspective view of the filter device of FIG. 1 having a cap.

FIG. 6A is a front plan view of the filter device of FIG. 1.

FIG. 6B is a side plan view of the filter device of FIG. 1.

FIG. 6C is a top plan view of the filter device of FIG. 1.

FIG. 6D is a bottom plan view of the filter device of FIG. 1.

FIG. 7 is a diagrammatic view of the filter device of FIG. 1 showing the direction of fluid flow.

FIGS. 8A-D are views of alternate embodiments of the filter plates of the filter device of FIG. 1.

FIG. 9 is a perspective view of the filter device of FIG. 1 with a filter plate removed therefrom.

FIG. 10 is a perspective view of the filter device of FIG. 1 as installed.

FIG. 11 is a perspective view of an additional embodiment of the filter device of the present invention as installed.

FIG. 12 is a front perspective view of the interior of the filter device of FIG. 11.

FIG. 13 is a perspective view of a further embodiment of the filter device of the present invention.

FIG. 14 is a diagrammatic view of the filter device of FIG. 13 showing the direction of fluid flow.

### DETAILED DESCRIPTION OF THE INVENTION

The present application relates to a device for separating debris from a fluid so as to prevent clogging of a pipe or waterway through which the fluid flows. The device provides a housing having a filter cartridge therein, wherein the filter cartridge is not in the direct flow path of the fluid entering the housing so that debris in the fluid remains in a lower chamber of the housing while the fluid flows upwardly through the filter cartridge and the filtered fluid flows out of the upper chamber of the housing through a first outlet thereof. The device further includes a second outlet that allows for purging or cleaning of the lower chamber of the filter device to remove debris accumulated therein.

The present application in some embodiments will be described using words such as “upper” and “lower,” “inner” and “outer,” “right” and “left,” “interior” and “exterior,” and the like. These words and words of similar directional import are used for assisting in the understanding of the invention when referring to the drawings or another component of the invention and, absent a specific definition or meaning otherwise given by the specification, such terms should not be considered limiting to the scope of the invention.

The present invention can be used to filter any of various types of fluids having debris therein, such as air or gas streams, water, and mixtures of water with various other liquids. Such fluids and mixtures having debris shall be referred to herein simply as “contaminated fluids” for convenience.

While the filter device of the present application is particularly useful for filtering hair or hair clippings from a contaminated fluid, the filter device of the present application can be used to filter various types of debris such as particulate matter, dirt, sediment, lint, fibers, hair, and chemical or biologic contaminants, among others, and the present application will refer to any and all such materials simply as “debris.”

While the filter device is described as being particularly useful in a salon or barbershop to filter hair from the used water from a sink, wash basin, tub or the like, it is understood that this environment is illustrative and is not limiting, and that the filter device can be used to filter various types of fluids having various types of debris in a number of different settings, such as in household or residential settings, textile processing, food processing, laundry facilities, or pet or animal grooming, among others.

The present application relates to a filter device having a housing of any of various sizes, shapes, and configurations. In a preferred embodiment, the housing has a rectangular prism or cubic configuration. A filter cartridge configured to separate the debris from the contaminated fluid is positioned in the housing and divides the interior volume of the housing into a lower chamber and an upper chamber. The housing has at least one inlet that allows contaminated fluid to be communicated into the housing, and particularly into the lower chamber of the housing, from a washbasin, sink or the like. The housing may have several inlets so that contaminated fluid from several wash basins or sinks can be supplied to the housing, allowing the filter device to filter contaminated fluids from each of the wash basins before the fluid passes to a sewer or septic system. The fluid in the lower chamber must pass upwardly through the filter cartridge in order to enter the upper chamber of the housing. The housing further includes at least one first outlet that allows filtered fluid in the upper chamber to exit the housing.

The housing may define an open portion providing access to the interior volume of the housing. A door is provided and may be removably positioned over the open portion such that the door forms part of the housing defining the interior volume when in a closed configuration. The door may be pivotally connected to the housing, such as by a hinge. Alternatively, the door may be fully removable, wherein the door is secured to the housing via one or more fasteners. The door may further include a gasket or seal that is preferably composed of an elastomer, such as ethylene propylene diene (EPDM) rubber, for forming an airtight and/or water-tight seal with the housing when in the closed configuration. The door can be moved to an open configuration to provide access to the interior volume of the housing for cleaning and/or for removal or replacement of a filter cartridge therein.

The filter device further includes a filter cartridge having one or more filter plates, wherein each filter plate includes a perforated section having a plurality of apertures sized to allow fluid to pass therethrough while preventing debris from passing therethrough. When the filter cartridge has multiple filter plates, the filter plates may be connected and secured to one another or may be separate, independently movable components. The filter cartridge is positioned within the interior volume of the housing and extends fully between the walls thereof so as to define an upper chamber and a lower chamber within the housing, wherein the fluid must pass upwardly through the filter cartridge to move from the lower chamber to the upper chamber. While generally terms of directional import are merely illustrative, in this aspect, the direction of fluid flow through the filter cartridge must be in a vertically upward or generally upward direction. In this way, the contaminated fluid entering the housing is not driven into the filter cartridge by the force of flowing water entering the housing or by gravity, which may drive debris into the filter cartridge, blocking and clogging the filter as may occur with conventional top-down type filtration devices or other devices having the filter element perpendicular to or directly in the flow path of the contaminated fluid entering the filter device.

Preferably, the filter cartridge is positioned substantially horizontally within the housing. However, in alternate embodiments, the filter cartridge may be disposed at an angle relative to a horizontal plane, or the filter cartridge may include a stepped configuration wherein the various filter plates of the filter cartridge are disposed at different elevations or in different orientations with respect to one another. The filter cartridge is preferably positioned above an uppermost portion of the at least one inlet so that fluid entering the housing must pass through the filter cartridge in order to flow to the upper chamber and through a first outlet of the housing.

Each filter plate of the filter cartridge has a perforated section with a plurality of apertures. The perforated section may cover substantially the entire filter plate. In alternate embodiments, the perforated section covers only a portion of the filter plate, such as a central portion thereof, wherein the remainder of the filter plate is solid and is not perforated. The filter plates may be composed of any of various materials including but not limited to metal, hard plastic, fiberglass, or ceramics, among others. The perforated section of the filter plate may be a mesh screen, a porous membrane, or a panel having openings therein. The apertures are sized so as to allow fluid to pass freely therethrough while preventing debris from passing therethrough. In some embodiments, the filter cartridge includes multiple filter plates so that subsequent filter plates are used to capture debris that is able to pass through a first filter plate. Subsequent filter plate(s) may have smaller apertures or successively smaller apertures so as to prevent finer debris from passing therethrough. The filter plates may have a border disposed on the perimeter thereof that facilitates securement of the filter plate to a filter support and/or directly to the housing.

In some embodiments, the filter cartridge is removably positioned within a filter support in the housing. In this way, a user can remove the filter cartridge for cleaning or disposal and can replace the filter cartridge with a cleaned filter cartridge or a new filter cartridge. The filter support may be in the form of one or more slots disposed within the housing that slidably receive and support a filter cartridge or a filter plate of the filter cartridge. The slots may be integrally formed as recesses in the interior surface of opposing sidewalls of the housing or may be formed via upper and lower projections on the interior surfaces of the sidewalls of the housing. In alternate embodiments, the filter support may be clamps, clips, or other releasable fastening devices configured to secure and maintain the filter cartridge or its individual filter plates in position within the housing.

The filter device further includes a second outlet on a lower end of the housing. The second outlet may include a selectively openable closure thereon, such as a valve and particularly a gate valve, and may further have a removable cap. The selectively openable closure can be opened in order to remove accumulated debris from the lower chamber. The debris is removed under the force of gravity or the user may manually remove the debris. Further, the user may connect a hose from a vacuum to the second outlet of the filter device to more rapidly and easily draw the debris from the lower chamber of the housing.

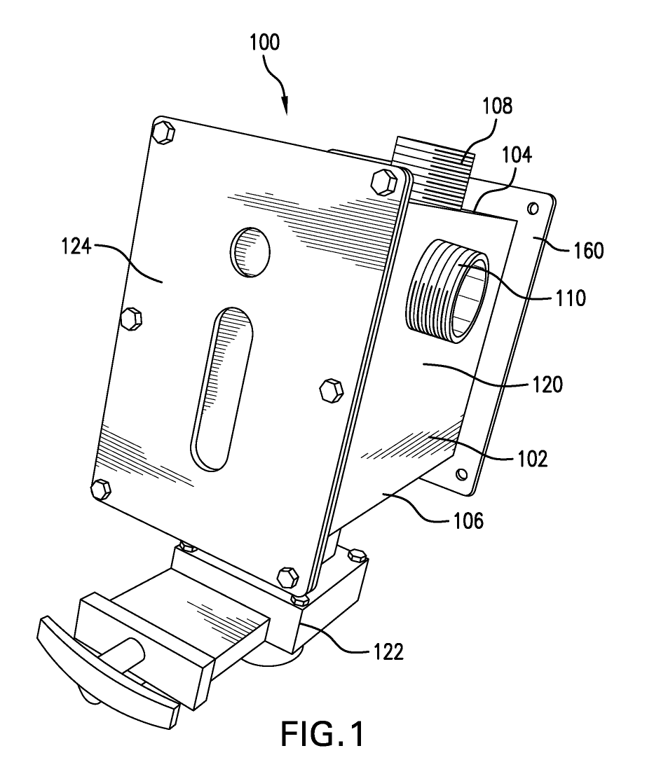

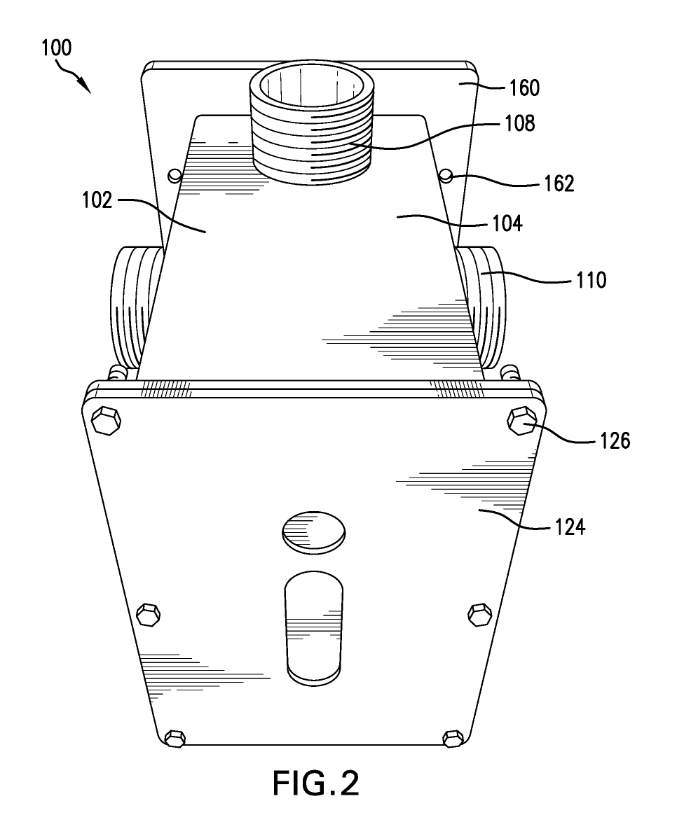

A preferred embodiment of the filter device of the present invention is shown in FIGS. 1-10. The filter device 100 comprises a housing 102 defining an interior volume. A filter cartridge 112 is positioned within the housing 102 so as to divide the interior volume of the housing 102 into an upper chamber 116 and a lower chamber 114. The housing 102 includes at least one inlet 108 that allows fluid to enter the lower chamber 114 of the housing 102 through the inlet 108 in a substantially horizontal direction. The fluid in the lower chamber 114 must flow vertically or in a generally upward direction through the filter cartridge 112 to reach the upper chamber 116, and the filtered fluid in the upper chamber 116 can escape the housing 102 via at least one first outlet 110 positioned on an upper end of the housing 102. A second outlet 118 is positioned so as to allow accumulated debris to be purged from the lower chamber 114 of the housing 102.

The housing 102 of the filter device 100 is oriented so as to have an upper end 104 and a lower end 106. In the illustrated embodiment, the housing 102 is configured as a rectangular prism. However, in alternate embodiments, the housing 102 can have any of various configurations, such as a cubic, cylindrical, spherical, or other polyhedral or non-geometric shape. Further, the precise dimensions and volume of the housing 102 can be adjusted depending upon the volume of contaminated fluid desired to be filtered.

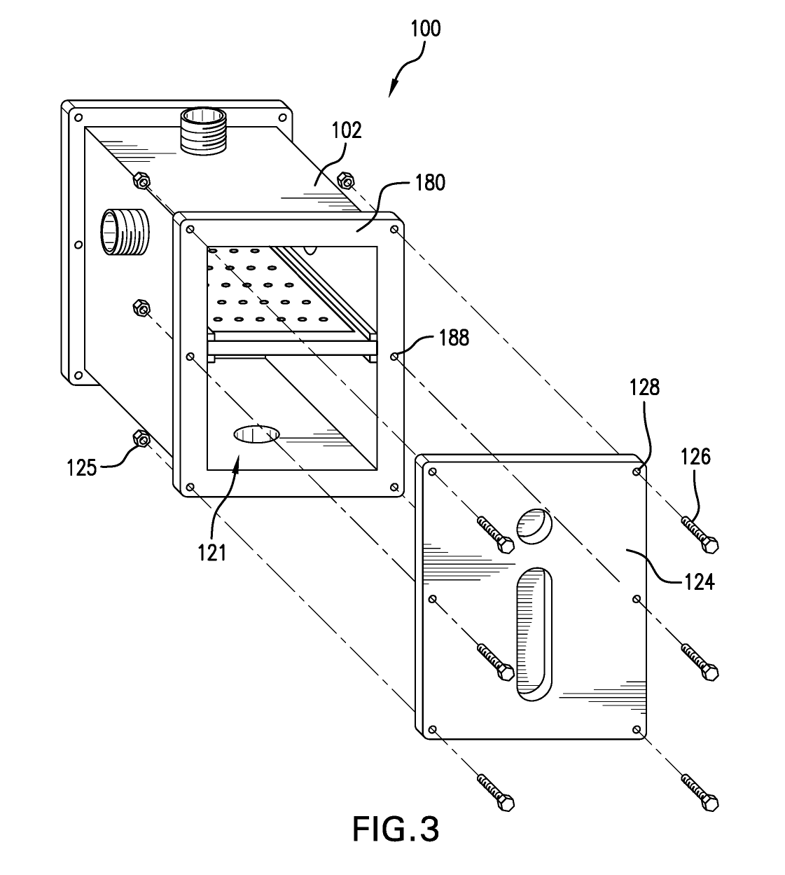

Referring now to FIG. 3, there is shown a perspective view of the filter device of FIG. 1 with the door removed therefrom. The housing 102 may define an open portion 121 providing access to the interior volume of the housing 102. In such embodiments, the filter device 100 further includes a door 124 that serves as a wall of the housing 102 that covers the open portion 121 when the door 124 is in a closed configuration. The door 124 may be removed from the housing 102 so as to provide access to the interior volume of the housing 102 through the open portion 121, so that a user can access the interior volume of the housing 102 to remove, clean, and/or replace a filter cartridge 112. The door 124 may further include a gasket or seal (not shown) for forming an airtight and/or water-tight seal with the housing 102 when in a closed configuration. The door 124 can be pivotally connected to the housing 102 via one or more hinges or can be fully removable therefrom.

The housing 102 may include a flange 180 surrounding and defining the open portion 121 of the housing 102. The flange 180 has a plurality of openings 188 through which a fastener 126, such as a bolt, among other fasteners can be inserted. The door 124 also includes a plurality of openings 128 on a peripheral portion thereof, wherein the number of openings 188 on the flange 180 is the same as the number of openings 128 on the door 124. When the door 124 is positioned over the open portion 121 of the housing 102 so as to cover the same, the openings 128, 188 on the door 124 and flange 180 align such that the fasteners 126 can be inserted through the aligned openings 128, 188. With the fasteners 126 inserted through the aligned openings 128, 188, a plurality of securement members 125 can be secured to the fasteners 126, if necessary, in order to secure the door 124 in the closed configuration. The securement members 125 may be tool-free so that they can be fully tightened by hand. In one embodiment, the fasteners 126 may be bolts and the securement members 125 may be nuts. In an alternate embodiment, the door 124 can be positioned in the closed configuration so that it overlaps with the flange 180 and an impact gun can be used to drive a bolt or other similar fastener through the door 124 and flange 180 to secure the door 124 to the flange 180.

The housing 102 includes at least one inlet 108 that allows fluid to enter the interior volume of the housing 102, and specifically the lower chamber 114 thereof. In some embodiments, a sidewall 120 of the housing 102 may define an opening that serves as the inlet 108 which provides access to the interior volume of the housing 102 from the exterior thereof. The exterior surface of the sidewall 102 defining the opening may include an outwardly extending connector around or adjacent to the inlet 108 to facilitate connection of a conduit to the housing 102 in order to supply fluid to the housing 102 through the inlet 108. The inlet 108 may be formed on a sidewall 120 of the housing 102 towards the lower end 106 of the housing 102, such that the fluid enters the housing 102 in a substantially horizontal direction.

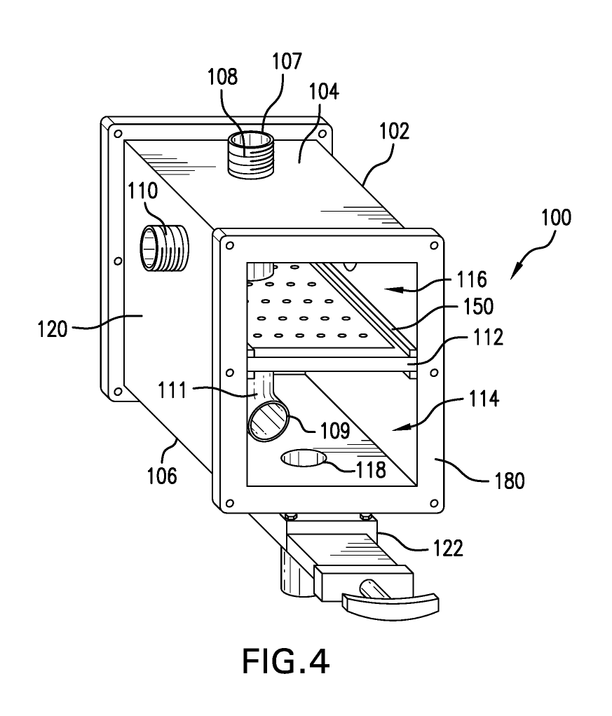

Alternatively, as shown in FIG. 4, the inlet may be in the form of an inlet tube 108 having a first end 107 and a second end 109. The inlet tube 108 is preferably positioned substantially vertically so that the first end 107 of the inlet tube 108 is disposed at an upper end 104 of the housing 102, and the second end 109 is positioned at a lower end of the housing 102 within the interior volume thereof so as to communicate fluid into the lower chamber 114. Preferably, the first end 107 of the inlet tube 108 is positioned on the upper end 104 of the housing 102 and extends outwardly therefrom. The portion of the inlet tube 108 extending outwardly from the upper end 104 of the housing 102 may be substantially straight or may be disposed at an angle relative to a longitudinal axis of the inlet tube 108 to facilitate connection to a conduit supplying contaminated fluid from a wash basin, sink or the like. A portion of the inlet tube 108 may extend through the interior volume of the housing 102, or the inlet tube 108 may be positioned outside of the housing 102. The inlet tube 108 may be formed integrally with the housing 102 or may be a separate component. The second end 109 of the inlet tube 108 is preferably disposed substantially horizontally so as to direct fluid into the lower chamber 114 in a horizontal direction. Thus, the inlet tube 108 may form a bend or elbow 111 toward the second end 109 thereof.

The housing 102 can be placed in fluid communication with a conduit from a wash basin or the like via the inlet 108 such that fluid from a wash basin can flow through the conduit and into the interior volume of the housing 102. The housing 102 may have a plurality of inlets for receiving fluid from a plurality of wash basins. Alternately, the conduits from each of the plurality of wash basins may merge prior to entering into the housing 102 through a single inlet on the housing 102.

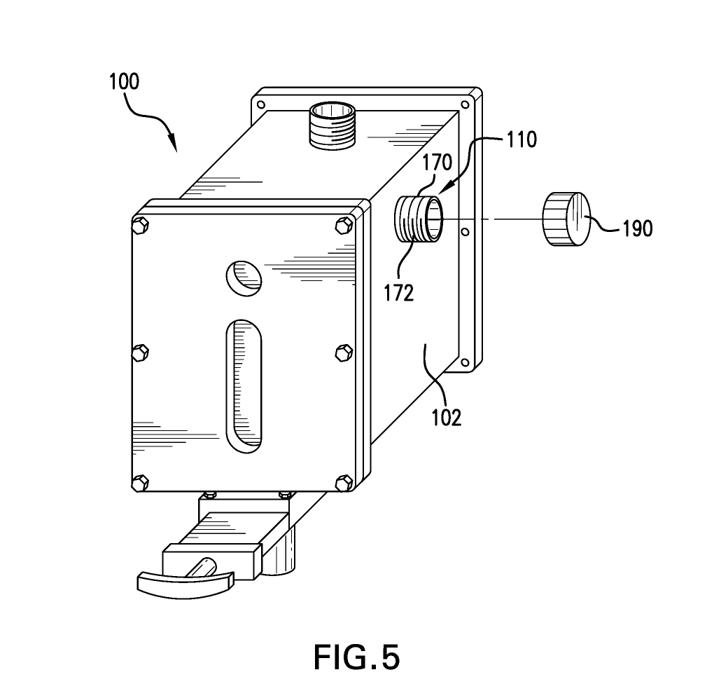

The housing 102 further includes one or more first outlets 110. The first outlet 110 is located at an upper end 104 of the housing 102 so as to allow filtered fluid to exit the upper chamber 116 of the housing 102 through the first outlet 110. Each first outlet 110 may be an opening defined by a sidewall 120 of the housing 102 that allows fluid to flow from the interior volume of the housing 102 and the exterior thereof. The first outlet 110 may be positioned on any portion of the housing 102 relative to the inlet(s) 108, such as on a portion of the housing 102 opposite the inlet 108 or orthogonal thereto. The housing 102 may further include an outwardly extending connector 170 adjacent to the first outlet 110 on the exterior surface of the sidewall 120 of the housing 102, and surrounding the first outlet 110 for facilitating connection of a conduit to the housing 102, as shown in FIG. 5. Thus, the first outlet 110 is configured to engage with a conduit or pipe to carry filtered fluid from the housing 102 and towards the sewer, water treatment system, septic system, or the like.

In the illustrated embodiment, the filter device 100 includes two first outlets 110 that are positioned on opposing sides of the housing 102. In this way, the filter device 100 can be adapted for use with existing piping and plumbing fixtures, and the user can select which first outlet 110 is more convenient for connection to existing piping. Alternatively, if desired, the user can utilize both first outlets 110 to facilitate fluid flow exiting the filter device 100.

In embodiments having more than one first outlet 110, one or more caps 190 may be provided that can each be positioned over a first outlet 110 so as to block the flow of fluid therethrough, as shown in FIG. 5. For example, if the filter device 110 includes two first outlets 110 on opposing sides of the housing 102, and for installation purposes it is desired that filtered fluid exits through only one side of the housing 102, one of the first outlets 110 can be covered by the cap 190. The cap 190 is configured to engage with an outlet connector 170 positioned on an exterior of the housing 102 around a first outlet 110. The outlet connector 170 preferably has a threaded exterior 172 configured to rotatably engage with a threaded interior of the cap 190. The threaded connection facilitates installation and removal of the cap 190 without the use of tools.

The housing 102 of the filter device 100 further includes a second outlet 118 that is an opening defined by the housing 102 at a lower end 106 thereof, wherein the second outlet 118 is in fluid communication with the lower chamber 114 of the housing 102. The second outlet 118 is preferably located at a lowermost portion of the housing 102. The second outlet 118 may be located centrally at the lowermost portion of the housing 102 or may be positioned offset from the center of the housing 102. Further, the lower end 106 of the housing 102 may be sloped downwardly towards the second outlet 118 so as to facilitate gravitational flow of contaminated fluid and debris towards and through the second outlet 118.

The second outlet 118 preferably includes a selectively openable closure 122. The selectively openable closure 122 may be formed integrally with the filter device 100 or may be removably secured to the housing 102 around or near the second outlet 118. The selectively openable closure 122 may be configured as a valve, such as a gate valve, among others. The selectively openable closure 122 is in a closed position when the filter device 100 is in use so that fluid and debris cannot escape therethrough, and a user can selectively actuate the selectively openable closure 122 so as to open the same, allowing the user to remove debris that has accumulated in the lower chamber 114 of the housing 102. With the selectively open closure 122 in an open configuration, the user may allow the fluid and debris in the lower chamber 114 to drain via gravity and/or the user may manually remove the same. Alternatively, the selectively openable closure 122 can be engaged with a hose of a vacuum so that the vacuum can be used to more rapidly and easily draw the fluid and debris from the lower chamber. The selectively openable closure 122 may alternatively or additionally include a removable cap or cover that can be removably secured to the second outlet 118 by hand so as to provide access to the lower chamber 114 so that a user can remove debris collected within the lower chamber 114, and wherein the cap helps to prevent accident drainage of fluid and debris from the housing 102.

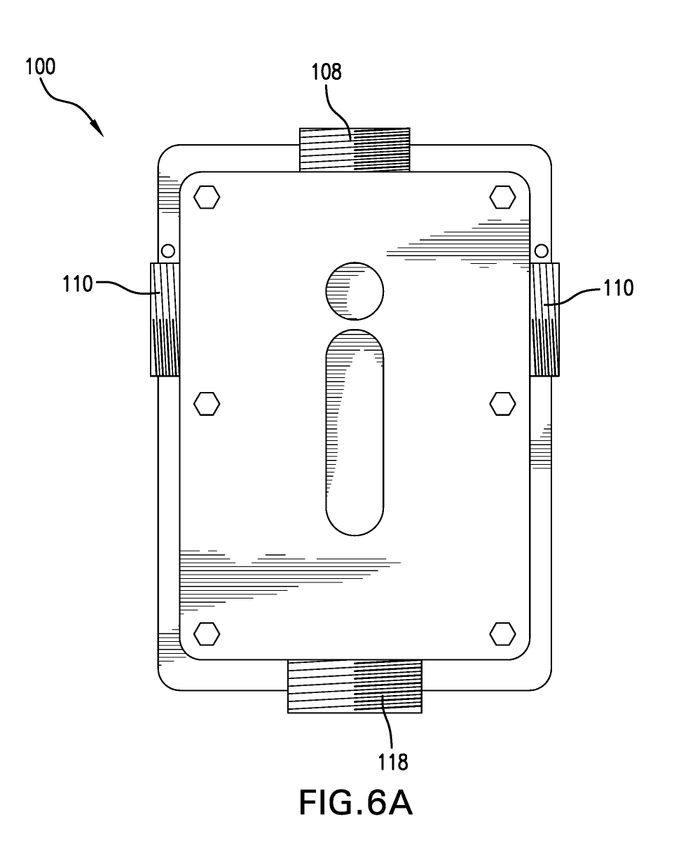

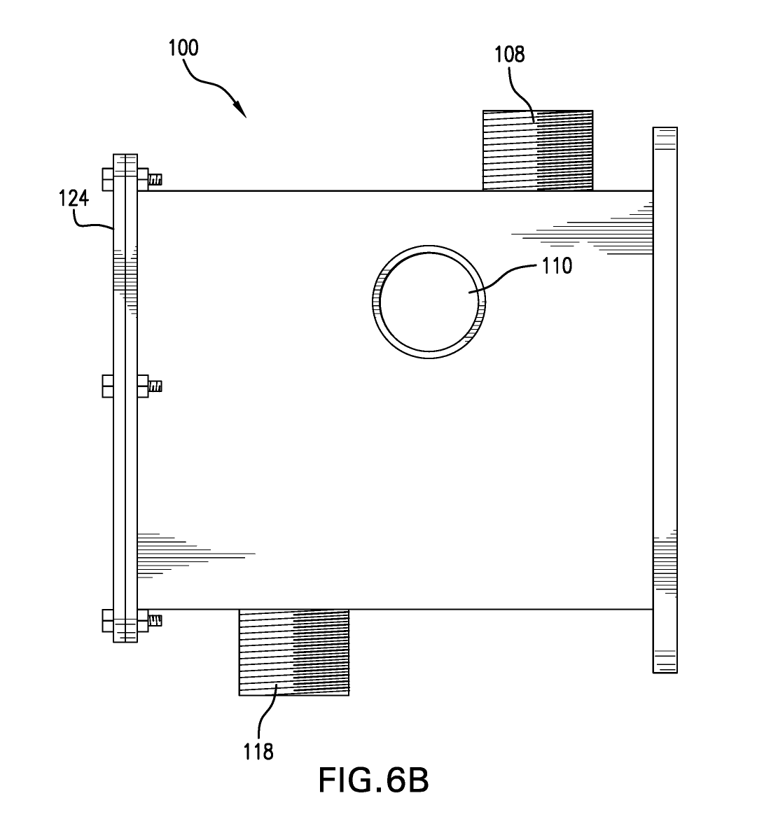

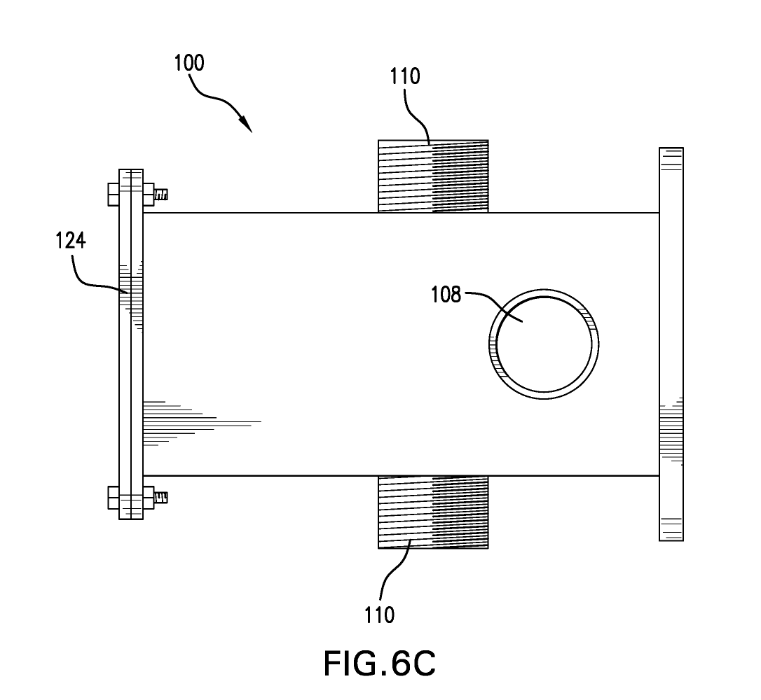

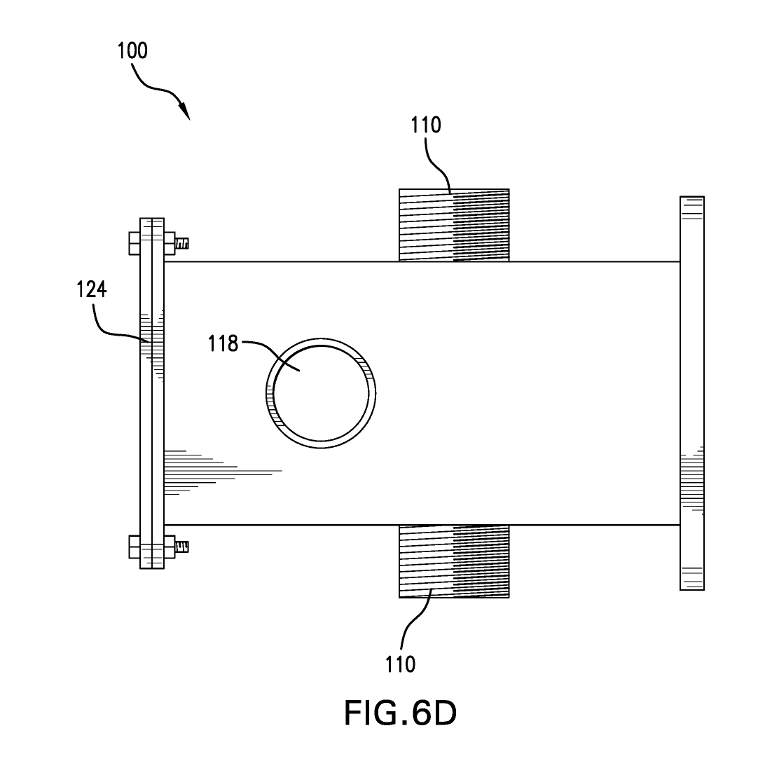

Referring now to FIGS. 6A-6D there are shown plan views of the filter device of FIG. 1. In the illustrated embodiment. The filter device 100 includes an inlet 108 on an upper end of the housing 102, and in operation, fluid passes through the inlet 108 into the lower chamber of the interior volume of the housing. The inlet 108 is preferably positioned towards a rear portion of the housing 102. The first outlet(s) 110 are positioned towards an upper end of the housing 102 and in the illustrated embodiment, two first outlets 110 are shown are disposed directly opposite one another. The first outlets 110 can be arranged in various relationships with respect to one another, and may be positioned on the same side of the housing 102 or on opposing sides but without being directly opposite one another. Further, the second outlet 118 is positioned at a lower end of the housing, and preferably on a bottom wall or surface thereof. In the illustrated embodiment, the second outlet 118 is located at a front portion of the housing towards the door 124 of the housing 102. The second outlet 118 is shown without a selectively openable closure, and may include a tube, outlet connector or conduit therearound to facilitate connection of a selectively openable closure to the housing 102.

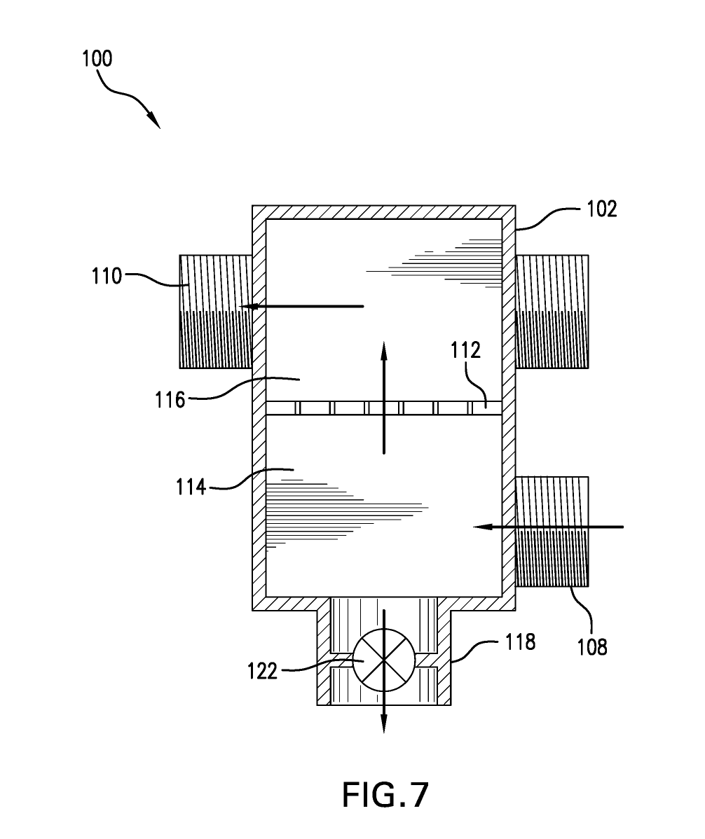

The filter device 100 further includes at least one filter cartridge 112 as shown in FIG. 7. While FIG. 7 shows the inlet 108 positioned at a lower end of the housing 102, it is understood that the inlet 108 can be positioned at various locations on the housing 102 so long as the inlet 108 communicates fluid to the lower chamber of the interior volume of the housing 120 and preferably so that fluid flows into the housing 102 in a substantially horizontal direction. The filter cartridge 112 is preferably positioned substantially horizontally within the housing 102 and extends between the sidewalls thereof. The filter cartridge 112 is positioned at an elevation within the housing 102 that is at or above the highest portion of the inlet(s) 108. The filter cartridge 112 is also positioned below the lowermost portion of the first outlet(s) 110. In this way, the filter cartridge 112 divides the housing 102 into a lower chamber 114 and an upper chamber 116, wherein contaminated fluid supplied to the housing 102 through the inlet 108 must pass upwardly through the filter cartridge 112 in order to move from the lower chamber 114 to the upper chamber 116. Further, the lowermost portion of the first outlet(s) 110 is preferably disposed at an elevation above the uppermost portion of the inlet 108, and preferably about 2 inches thereabove, so as to form a water-gas seal within the filter device 100. The filtered fluid can exit the upper chamber 116 via the first outlet(s) 110, and the filter cartridge 112 prevents debris from passing therethrough, trapping the debris in the lower chamber 114.

The contaminated fluid flows in a substantially horizontal direction into the housing 102 through the inlet 108 and since the filter cartridge 112 is located above the inlet 108, the filter cartridge 112 is not in the flow path of the fluid flowing into the housing 102, and is instead positioned substantially parallel to the direction of the incoming flow of contaminated fluid. As contaminated fluid enters the housing 102, the incoming fluid rises within the filter device 100 and passes through the filter cartridge 112 while debris is retained within the lower chamber 114. Thus, neither the flow of contaminated fluid into the housing 102 nor gravity drives the debris into the filter cartridge 112. The debris is retained within the lower chamber 114 and settles to the bottom of the housing 102, helping to prevent the filter cartridge 112 from clogging.

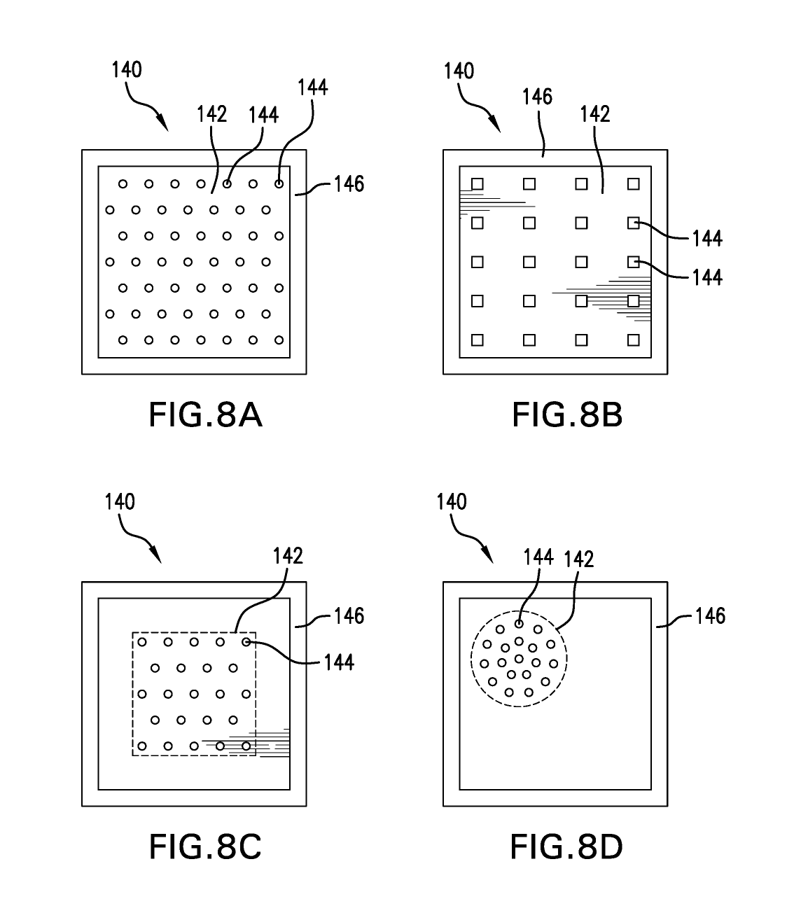

Referring now to FIGS. 8A-D, there are shown several embodiments of a filter plate of the filter cartridge of the filter device of FIG. 1. The filter cartridge 112 has one or more filter plates 140 that can be connected to one another as a single unit, or can be separate components such that the filter plates 140 can be individually removed and/or replaced. Each filter plate 140 has a perforated section 142 with a plurality of apertures 144 stamped or otherwise formed thereon. The perforated section 142 may cover only a portion of the filter plate 140 as in FIGS. 8C and 8D and may be positioned at a central portion or peripheral portion thereof, or the perforated section 142 may substantially cover the filter plate 140 as in FIGS. 8A and 8B. The filter plates 140 may have a substantially square or rectangular configuration and the perforated section 142 may also have a square configuration and may substantially cover the entire filter plate 140. The filter plates 140 may be composed of any of various materials including but not limited to metal, hard plastic, fiberglass, or ceramics, among others, and is preferably formed of a corrosion-resistant material, such as stainless steel. The perforated section 142 of the filter plate 140 may be in the form of a mesh screen, a porous membrane, or a panel having apertures therein.

The apertures 144 of the perforated section 142 of the filter plate 140 allow fluid to flow therethrough while preventing debris from passing therethrough. The apertures 144 are preferably arranged in a grid-like pattern or are otherwise arranged in a regular pattern, but may be arranged randomly. Preferably, the plurality of apertures 144 are arranged in several rows, wherein each aperture 144 in the same row is separated by a fixed distance. The distance between each aperture 144 is preferably approximately ⅛ inch, wherein the distance is measured as the straight line distance between the edge of a first aperture to the adjacent edge of a second aperture. Preferably, adjacent rows of apertures 144 are staggered, such that every other row is offset or indented from the previous row of apertures 144 by approximately 1/16 inch, to form a staggered pattern as shown for example at FIG. 8A. In a preferred embodiment, the perforated section 142 is constructed so as to have apertures 144 sized to prevent human hair or hair clippings from passing therethrough. Preferably, the width/diameter of the apertures 144 is about 0.5 mm to about 5 mm. A person having ordinary skill in the art can readily adjust the size of the apertures of the perforated section 142 of the one or more filter plates 140 to prevent the passage of debris to be filtered while allowing fluid to flow therethrough. The apertures 144 may have a substantially circular shape. However, in alternate embodiments, the apertures 144 may have various other shapes, such as a triangular, oval, or square shape as in FIG. 8B, among other shapes.

In some embodiments, the filter cartridge 112 or each filter plate 140 thereof has a border 146 about its perimeter, wherein the border 146 facilitates securement of the filter cartridge 112 to a filter support 150 disposed within the housing 102. Thus, the border 146 may be thicker than the filter cartridge 112 or each individual filter plate 140 and may be composed of a material configured to create a seal with the filter support 150 and/or the housing 102 to prevent fluid flow around the perimeter of the filter cartridge 112. The filter cartridge 112 is preferably sized so as to fit closely against the filter support 150 and/or to the walls of the housing 102.

In some embodiments, the filter cartridge 112 comprises two filter plates 140. The filter plates 140 are both positioned substantially horizontally so as to be parallel to one another and are separated by a space. Preferably, the space separating the filter plates 140 is about 0.5 cm to about 10 cm. The filter plates 140 may have the same or different sized apertures. In embodiments wherein the filter plates 140 have the same sized aperture, the second or upper filter plate 140 of the two filter plates 140 may be used to catch any debris, such as hair, that was able to pass through the first or lower filter plate 140. In embodiments wherein the filter plates 140 have different sized apertures 144, the first filter plate 140 may have larger apertures than the second filter plate 140, so that the second filter plate 140 prevents the passage of finer debris that was able to pass through the first filter plate 140. However, in alternate embodiments, the filter cartridge 112 may comprise any number of filter plates 140 having any of various configurations and any of various aperture sizes.

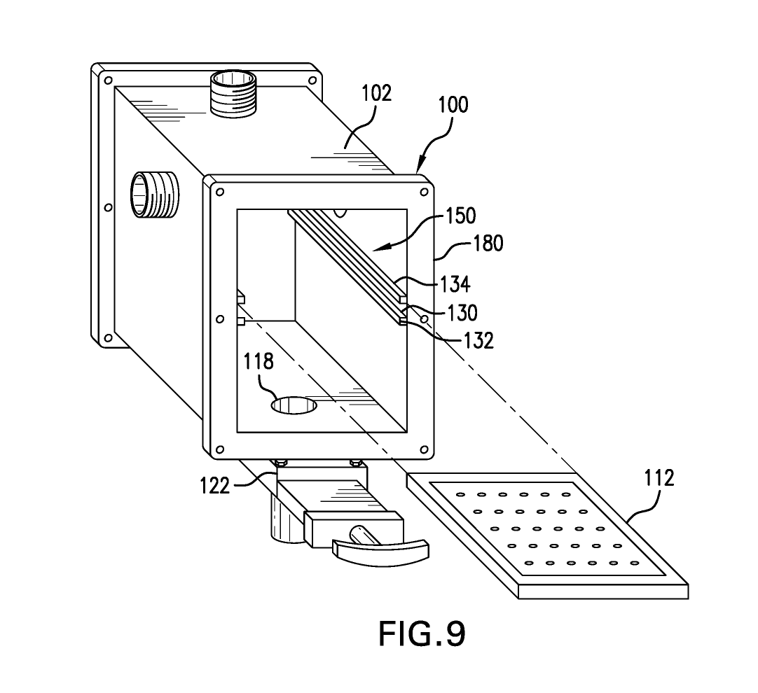

Referring now to FIG. 9, there is shown a perspective view of the interior of the filter device with the filter cartridge removed. The filter device 100 includes a filter support 150 configured to securely position the filter cartridge within the housing 102. In one embodiment, the filter support 150 includes one or more slots 130 configured to slidably receive the filter cartridge 112 or each filter plate 140 thereof and support the filter cartridge 112 in the appropriate orientation within the housing 102. The slots 130 may include recessed areas integrally formed in the interior surface of the sidewalls of the housing 102. Alternatively, the slots 130 may be formed between a lower projection 132 and an upper projection 134 on the interior surface of the sidewall of the housing 102, as shown in FIG. 9. When the filter cartridge 112 is inserted into the slot 130, the filter cartridge 112 forms a watertight seal with the housing 102 so that fluid cannot escape the interior volume of the housing 102. In alternate embodiments, the filter support 150 may secure the filter cartridge 112 in the desired configuration via the use of clips or clamps, among other releasable fasteners. The filter cartridge 112 may be permanently secured within the housing 102, such as via welding, adhesives or by mechanical fasteners, such as bolts or screws or the like.

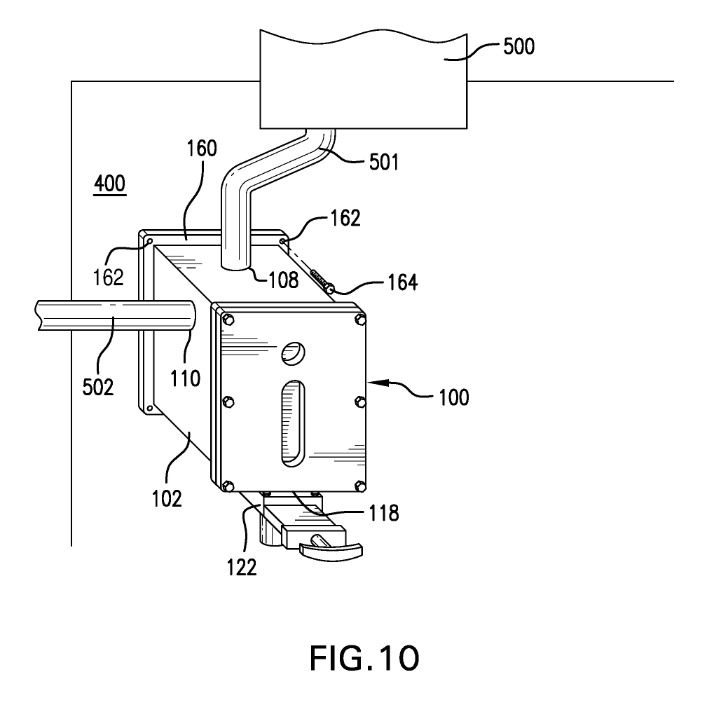

Referring now to FIG. 10, there is shown a perspective view of the filter device of FIG. 1 as installed. In operation, the filter device 100 can be installed so as to receive contaminated fluid from a wash basin 500 or the like. A conduit 501 from a wash basin 500 is secured to the inlet 108 so that contaminated water is communicated into the housing 102. A second conduit 502 is connected to the first outlet 110, such as by means of an outlet connector, so that fluid filtered by the filter device 100 can flow to a sewer, water treatment plant, or the like.

The filter device 100 may be supported solely via the connection to the conduits 501 and 502, such as when the conduits are pipes. In some embodiments, as presently shown, the filter device 100 may further include a mounting plate 160 fixed to the housing 102 and configured to facilitate mounting the filter device 100 to a support surface 400, such as a wall. The mounting plate 160 is preferably planar so that it can be placed in facing engagement with a support surface 400. The mounting plate 160 includes a plurality of apertures 162 through which a mounting fastener 164 can be inserted for securing the mounting plate 160, and thus the filter device 100 to the support surface 400. The mounting fastener 164 may be any suitable fastener for securing the filter device 100 to the support surface 400, such as a screw, bolt, nail, or the like. The filter device 100 is preferably installed at an elevation above the ground or floor-level so as to provide space beneath the second outlet 118 to allow debris to be removed from the filter device 100.

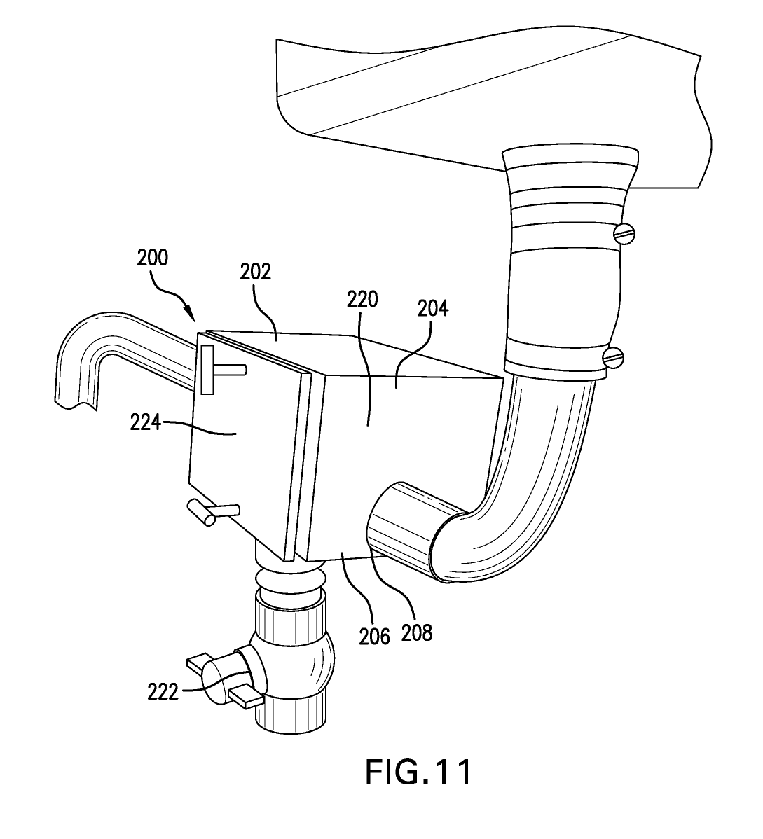

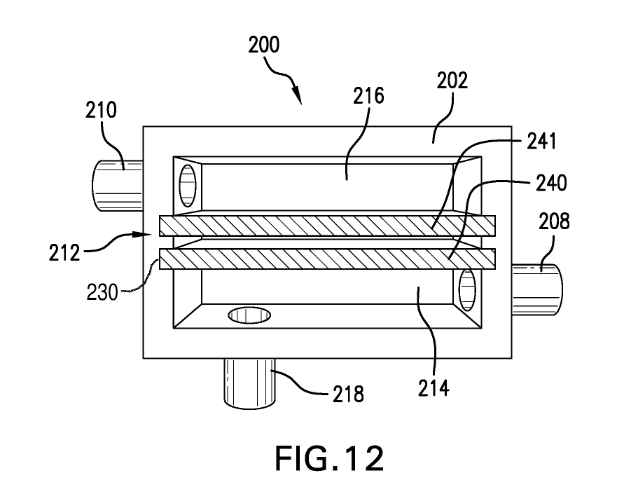

Referring now to FIGS. 11-12, there is shown a further embodiment of the filter device according to the present invention. The filter device 200 is substantially the same as the filter device according to FIGS. 1-10 and includes a housing 202 having a filter cartridge 212 that divides the interior volume of the housing into an upper chamber 216 and a lower chamber 214, at least one inlet 208 providing fluid to the lower chamber 214, at least one first outlet 210 that allows filtered fluid to exit the housing 202, and a second outlet 218 which may include a selectively openable closure 222 for removing or draining debris from the lower chamber 214. The filter device 200 includes an open portion that provides access to the interior volume of the housing 202 that is removably covered by a door 224. However, in the illustrated embodiment, the inlet 208 is formed as an opening on a lower end 206 of a sidewall 220 of the housing 202 so that fluid is communicated into the lower chamber 214 of the housing 202 in a substantially horizontal direction.

In the illustrated embodiment, the filter cartridge 212 includes a first filter plate 240 and a second filter plate 241. The filter plates 240, 241 are positioned parallel to one another and are separated by a space. The filter plates 240, 241 are independently formed and can be replaced independently of one another. The filter cartridge 212 is maintained and supported within the housing 202 by a filter support. The filter support is in the form of slots 230 formed integrally in the interior surface of the sidewall of the housing 202. The slots 230 removably receive the filter plates 240, 241 of the filter cartridge 212.

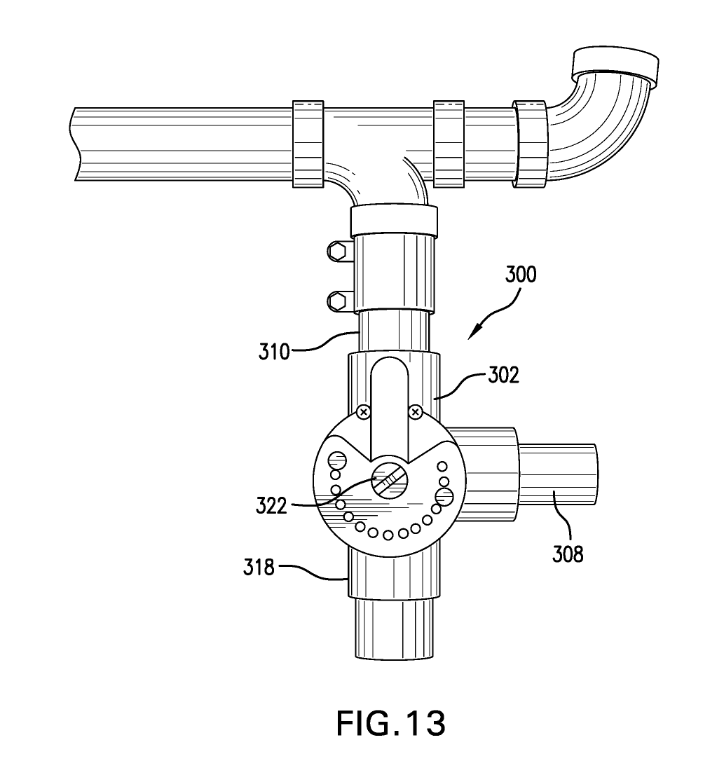

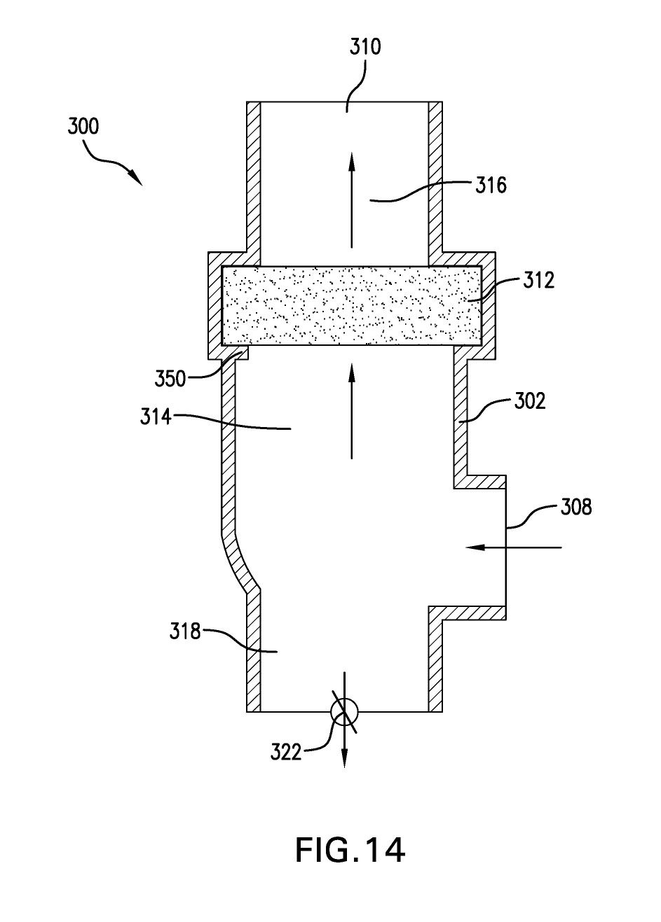

Referring now to FIGS. 13-14, there are shown views of an alternate embodiment of the filter device having a housing with a cylindrical configuration. The filter device 300 includes a housing 302 that is preferably positioned so that its longitudinal axis is in a substantially vertical orientation when the filter device 300 is in use. The illustrated embodiment provides a more compact configuration that is particularly suited for use in a home or where only a single wash basin or sink provides the contaminated fluid to be filtered. In the illustrated embodiment, the filter device 300 comprises a housing 302 having a cylindrical configuration, so as to resemble a pipe, wherein the housing 302 defines an interior volume. A filter cartridge 312 is positioned within the housing 302 so as to divide the interior volume into a lower chamber 314 and an upper chamber 316. The housing 302 may further comprise an open portion removably covered by a door (not shown) to facilitate access to the interior volume of the housing 302 for cleaning and/or removal or replacement of a filter cartridge 312 positioned therein.

Similar to the embodiment of FIGS. 1-10, the filter housing 302 includes at least one inlet 308. The inlet 308 is located on a lower end of the housing 302, and is preferably formed on a sidewall of the housing 302 so that fluid is provided into the housing 302 in a substantially horizontal direction relative to the longitudinal axis of the housing 302. A conduit from a wash basin or the like may be placed in fluid communication with the housing 302 via the inlet 308 to supply contaminated fluid to the housing 302.

The housing 302 further includes a first outlet 310 positioned at an upper end of the housing 302. The first outlet 310 may be formed at an upper end of the housing 302 or may be formed in a sidewall thereof. In the illustrated embodiment, the first outlet 310 is positioned on an opposing side of the housing 302 as the inlet 308. However, in alternate embodiments, the first outlet 310 may be positioned at any of various angles or orientations relative to the inlet 308 or may be positioned on the same side of the housing 302 as the inlet 308.

The filter cartridge 312 is positioned within the housing 302 at an elevation above the inlet 308 and below the first outlet 310. In this way, contaminated fluid that enters the lower chamber 314 of the housing 302 via the inlet 308 must flow in a vertical or generally upward direction through the filter cartridge 312 in order to exit the housing 302 via the first outlet 310, and debris is retained within the lower chamber 314 and is unable to pass through the filter cartridge 312.

The filter cartridge 312 is preferably positioned in the housing 302 in a substantially horizontal orientation. However, in alternate embodiments, the filter cartridge 312 may be disposed at an angle relative to a horizontal plane, or may have a stepped configuration wherein different filter plates of the filter cartridge are located at different elevations or are disposed in different orientations relative to one another. Depending on the embodiment, the filter cartridge 312 may include one or more filter plates. The filter cartridge 312 preferably has a substantially circular configuration so as to fit within the circular cross section of the housing 302. The filter cartridge 312 and/or its filter plates may comprise a border about a portion of the perimeter to facilitate insertion and securement of the filter cartridge 312 within a filter support 350. The filter support 350 may include a slot for removably receiving the filter cartridge 312, wherein once the filter cartridge 312 is positioned within the slot, the border of the filter cartridge 312 a seal with the housing 302 and/or with the filter support 350 to prevent fluid from escaping from the interior of the housing 302.

The filter device 300 further includes a second outlet 318 that is formed as an opening at a lower end of the housing, and is preferably located along the longitudinal axis of the housing 302. The housing 302 may include an outwardly extending tube, conduit, or flange about the second outlet 318 to facilitate connection to a pipe or other conduit. Further, the second outlet 318 may include a selectively openable closure 322. In some embodiments, the selectively openable closure 322 is a valve, such as a gate valve, that can be selectively opened so as to allow accumulated debris to be removed from the lower chamber 314. Additionally, the selectively openable closure 322 may include a removable cap that seals the second outlet when secured thereon. The removable cap may be threadably connected to threading on the second outlet.

In any embodiment of the filter device of the present invention described herein, the components of the filter device, such as the housing, may be composed of any of various suitable materials known in the art for the construction of waterways, pipes, and the like, including but not limited to metals and hard plastics, such as aluminum, polyvinyl chloride (PVC), chlorinated polyvinyl chloride (CPVC), cast iron, chromed brass, copper, chromed copper, galvanized iron, and cross-linked polyethylene, among others. Further, the filter cartridge may be composed of metal, corrosion-resistant and wear-resistant polymeric materials, or ceramic materials, among others. Preferably, the filter device and filter cartridge are composed of a corrosion-resistant material, such as stainless steel, so that the filter device does not deteriorate or corrode in the presence of drain-cleaning solutions or the like. The housing of the filter device may be of unitary construction or may be formed via a plurality of subparts.

In operation, a conduit for supplying contaminated fluid to be filtered, such as a drainpipe from a washbasin, can be connected to the housing at the inlet of the filter device such that the wash basin and housing are in fluid communication and contaminated fluid is supplied to the interior volume of the housing from the wash basin. An outlet pipe is placed in fluid communication with the housing via the first outlet, wherein filtered fluid exits the housing via the first outlet and the outlet pipe communicates that filtered fluid to a sewer, septic system, or other fluid or waste treatment system. A filter cartridge having one or more filter plates is positioned within the housing and maintained in the proper position by a filter support, wherein the filter cartridge divides the interior volume of the housing into and upper and lower chamber, wherein the fluid must pass upwardly through the filter cartridge to move from the lower chamber to the upper chamber. The debris is unable to pass through the filter cartridge and is maintained in the lower chamber until the selectively openable closure of the second outlet is opened to drain the accumulated debris.

It will be appreciated by those skilled in the art that changes could be made to the embodiments described above without departing from the broad inventive concept thereof. It is understood, therefore, that this invention is not limited to the particular embodiments disclosed, but it is intended to cover modifications within the spirit and scope of the present invention as defined by the appended claims.

We claim:

1. A filter device for separating debris from a fluid, comprising:
a housing defining an interior volume, wherein the housing has at least one inlet, at least one first outlet, and a second outlet; and
a filter cartridge configured to prevent debris from passing therethrough while allowing fluid to flow therethrough, wherein the filter cartridge is positioned within the housing so as to define an upper chamber and a lower chamber within the housing, wherein the at least one inlet is positioned such that a fluid can pass through the at least one inlet into the lower chamber of the housing, the at least one first outlet is positioned to allow fluid that has passed through the filter cartridge into the upper chamber to exit the housing through the at least one first outlet, and the second outlet is positioned so as to allow debris to be discharged from the lower chamber.

2. The filter device of claim 1, wherein the housing is a rectangular prism.

3. The filter device of claim 1, wherein the housing is substantially cylindrical.

4. The filter device of claim 1, wherein the housing has one or more sidewalls and wherein the filter cartridge extends between the one or more sidewalls such that a fluid entering the housing through the at least one inlet must pass through the filter cartridge in order to flow from the lower chamber to the upper chamber of the housing.

5. The filter device of claim 4, wherein the filter cartridge is positioned substantially horizontally within the housing.

6. The filter device of claim 1, wherein the at least one inlet is positioned so as to direct fluid into the lower chamber of the housing in a substantially horizontal direction.

7. The filter device of claim 1, wherein the at least one inlet is configured as an inlet tube having a first end and a second end, wherein the first end is disposed at an upper end of the housing, and the second end is disposed at a lower end of the housing and communicates fluid into the lower chamber of the housing.

8. The filter device of claim 7, wherein at least a portion of the inlet tube is positioned within the interior volume of the housing.

9. The filter device of claim 1, wherein the at least one inlet is configured as an opening defined by a sidewall of the housing, such that fluid can flow from an exterior of the housing through the at least one inlet into the interior volume of the housing.

10. The filter device of claim 1, wherein the housing comprises a flange defining an open portion, wherein the open portion provides access to the interior volume of the housing, and wherein the filter device further comprises a door configured to removably cover the open portion of the housing.

11. The filter device of claim 10, wherein the flange comprises a plurality of openings, and wherein the door comprises a plurality of openings that can be aligned with the plurality of openings on the flange when the door is in a closed configuration, such that a plurality of fasteners can be inserted through the aligned openings to secure the door to the flange.

12. The filter device of claim 1, wherein the filter cartridge comprises one or more filter plates, wherein each of the one or more filter plates comprises a perforated section having a plurality of apertures sized so as to prevent debris from passing therethrough.

13. The filter device of claim 12, wherein the perforated section of the one or more filter plates is centrally located on the filter plate.

14. The filter device of claim 1, wherein the filter cartridge is removably positioned within the housing.

15. The filter device of claim 1, further comprising a filter support configured to maintain and secure the filter cartridge within the housing.

16. The filter device of claim 15, wherein the filter support comprises one or more slots configured to receive the filter cartridge or a filter plate of the filter cartridge.

17. The filter device of claim 1, wherein the second outlet comprises a selectively openable closure configured to allow debris to be selectively removed from the lower chamber of the housing.

18. The filter device of claim 17, wherein the selectively openable closure is a valve.

19. The filter device of claim 1, further comprising a mounting plate fixed to the housing, wherein the mounting plate includes a plurality of apertures configured to receive fasteners therethrough, wherein the mounting plate is configured to be positioned against a support surface for mounting the housing to the support surface.

20. The filter device of claim 1, wherein the housing comprises stainless steel.

21. A method for filtering a fluid containing debris, comprising:
providing the filter device of claim 1;
supplying a fluid containing debris into the housing via the at least one inlet, wherein the fluid passes upwardly from the lower chamber through the filter cartridge to the upper chamber and outwardly through the at least one first outlet, and wherein the debris is unable to pass through the filter cartridge and is retained in the lower chamber of the housing.

22. The method of claim 21, further comprising:
opening the selectively openable closure so as to allow debris to be removed from the lower chamber of the housing.

23. A method for filtering a fluid containing debris, comprising:
supplying fluid to a filter device comprising a housing wherein a filter cartridge is positioned within the housing and is outside of the flow path of the fluid entering the housing, such that the fluid flows in a vertically upward direction through the filter cartridge.
